(19) United States
(12) Patent Application Publication
(10) Pub. No.: US 2016/0031920 A1
(43) Pub. Date: Feb. 4, 2016

(54) METAL ORGANIC FRAMEWORK MATERIALS

(71) Applicants: Partha Nandi, Bridgewater, NJ (US); Mobae Afeworki, Phillipsburg, NJ (US); Quddus Nizami, Piscataway, NJ (US); Simon C. Weston, Annandale, NJ (US)

(72) Inventors: Partha Nandi, Bridgewater, NJ (US); Mobae Afeworki, Phillipsburg, NJ (US); Quddus Nizami, Piscataway, NJ (US); Simon C. Weston, Annandale, NJ (US)

(73) Assignee: EXXONMOBIL RESEARCH AND ENGINEERING COMPANY, Annandale, NJ (US)

(21) Appl. No.: 14/736,730

(22) Filed: Jun. 11, 2015

Related U.S. Application Data
(60) Provisional application No. 62/030,194, filed on Jul. 29, 2014.

(51) Int. Cl. C07F 15/02; C07F 5/06; C07F 5/00; B01J 20/22; B01J 31/22

(52) U.S. Cl. CPC C07F 15/025; B01J 20/226; B01J 31/22; C07F 5/003; C07F 5/069; B01J 2231/005; B01J 2531/38; B01J 2531/31; B01J 2531/37

(57) ABSTRACT

An imidazolate framework material comprises a general structure, M¹-IM-M², wherein IM is an imidazolate or a substituted imidazolate linking moiety, such as a 4,5-dicyanoimidazolate or a hydrolyzed or substituted 4,5 dicyanoimidazolate linking moiety, wherein M¹ and M² comprise the same or different metal cations, wherein at least one of M¹ and M² comprises a trivalent metal cation and wherein neither M¹ nor M² comprises a monovalent cation.

### CROSS-REFERENCE TO RELATED APPLICATIONS

This application claims the benefit of U.S. Application Ser. No. 62/030,194, filed on Jul. 29, 2014; which is incorporated by reference herein in its entirety.

### FIELD OF THE INVENTION

This invention relates to metal organic frameworks, their synthesis and their use.

### BACKGROUND OF THE INVENTION

Metal organic frameworks (MOFs) are crystalline compounds consisting of metal ions or clusters coordinated to often rigid organic molecules to form one-, two-, or three-dimensional structures that can be porous. In some cases, guest molecules can stably enter the pores, thus MOF crystals can be used for the storage of gases such as hydrogen and carbon dioxide. Further, since sonic guest molecules can enter more easily than others, and the pores can be functionalized to change their chemical properties, this can be used as the basis for separation methodologies. For example, MOFs can be used to make highly selective and permeable membranes to separate small gas molecules (e.g., CO₂ from CH₄) or liquid molecules (e.g., hydrocarbons, alcohols, water). Additional applications of MOFs are in catalysis, in drug delivery, and as sensors.

Zeolitic imidazolate frameworks or ZIFs are a subset of metal-organic frameworks and have properties similar to inorganic zeolitic materials. ZIFs are based on [M(IM)₄] tetrahedral bonds in which IM is an imidazolate type linking moiety and M is a transition metal. These materials are generally referred to as zeolitic imidazolate frameworks or ZIFs since the angle formed by imidazolates (IMs) when bridging transition metals is similar to the 145° angle of the Si—O—Si bond in zeolites. ZIF counterparts of a large number of known zeolitic structures have been produced. In addition, porous framework types, hitherto unknown to zeolites, have also been produced. Discussion of this research can be found in, for example, the following publications from Yaghi and his co-workers: “Exceptional Chemical and Thermal Stability of Zeolitic Imidazolate Frameworks”, Proceedings of the National Academy of Sciences of U.S.A., Vol. 103, 2006, pp. 10186-91, “Zeolite A Imidazolate Frameworks”, Nature Materials, Vol. 6, 2007, pp. 501-6, “High-Throughput Synthesis of Zeolitic Imidazolate Frameworks and Application to CO₂ Capture”, Science, Vol. 319, 2008, pp. 939-43, “Colossal Cages in Zeolitic Imidazolate Frameworks as Selective Carbon Dioxide Reservoirs”, Nature, Vol. 453, 2008, pp. 207-12, “Control of Pore Size and Functionality in Isoreticular Zeolitic Imidazolate Frameworks and their Carbon Dioxide Selective Capture Properties”, Journal of the American Chemical Society, Vol. 131, 2009, pp. 3875-7, “A Combined Experimental-Computational Investigation of Carbon Dioxide Capture in a Series of Isoreticular Zeolitic Imidazolate Frameworks”, Journal of the American Chemical Society, Vol. 132, 2010, pp. 11006-8, and “Synthesis, Structure, and Carbon Dioxide Capture Properties of Zeolitic Imidazolate Frameworks”, Accounts of Chemical Research, Vol. 43, 2010, pp. 58-67.

Much of this work on ZIF structures is summarized in U.S. Patent Application Publication No. 2007/0202038, the entire contents of which are incorporated herein by reference. In particular, the '038 publication discloses a zeolitic framework, comprising the general structure: M-L-M, wherein M comprises a transition metal and L is a linking moiety comprising a structure selected from the group consisting of I, II, III, or any combination thereof:

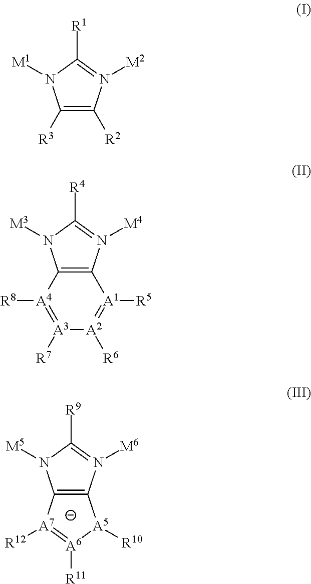

wherein A¹, A², A³, A⁴, A⁵, A⁶, and A⁷ can be either C or N, wherein R⁵-R⁸ are present when A¹ and A⁴ comprise C, wherein R¹, R⁴ or R⁹ comprise a non-sterically hindering group that does not interfere with M, wherein R², R³, R⁵, R⁶, R⁷, R⁸, R¹⁰, R¹¹, and R¹² are each individually an alkyl, halo-, cyano-, nitro-, wherein M¹, M², M³, M⁴, M⁵, and M⁶ each comprise a transition metal, wherein when the linking moiety comprises structure III, R¹⁰, R¹¹, and R¹² are each individually electron withdrawing groups.

In a more recent work by Ni et al., the structure and synthesis of mixed-valence ZIFs are disclosed in U.S. Patent Application Publication No. 2010/0307336. Specifically, the authors disclose in the '336 publication a porous crystalline material having a tetrahedral framework comprising a general structure, M¹-IM-M², wherein M¹ comprises a metal having a first valency, wherein M² comprises a metal having a second valency different from said first valency, and wherein IM is imidazolate or a substituted imidazolate linking moiety. Such materials can sometimes be described as iso-structural to known ZIF materials. In some embodiments, M¹ may comprise a monovalent metal and M² may comprise a trivalent metal.

ZIFs and other metal organic framework materials (MOFs) based on the imidazolate ligand have emerged as an attractive new platform for active materials for gas absorption, sensing (J. Am. Chem. Soc., 2010, 132 (23), pp 7832-7833), separation (J. Am. Chem. Soc., 2010, 132 (50), pp 17704-17706), and catalysis (e.g., ACS Catal., 2011, 1 (2), pp 120-127, ACS Catal., 2012, 2 (1), pp 180-183). In addition, in J. Inorg. Chem, 2011, 50, pp 12396-98. Norman et al. disclose strontium and barium imidazolate complexes which, under atomic layer deposition conditions using ozone as a reagent, can be used to deposit crystalline metal-containing films useful in the fabrication of dynamic random access memory (DRAM) and other electronic devices.

To date, however, most imidazolate framework materials that have been reported have a net divalent metal charge (whether all metals are 2+ valent or there is a combination of 1+ and 3+ valent metals). There is, therefore, interest in producing imidazolate framework materials with a wider range of metal valencies, for example, only trivalent metals.

### SUMMARY OF THE INVENTION

According to one aspect of the invention, an imidazolate framework material has now been synthesized wherein the composition comprises the general structure, M¹-IM-M², wherein IM is an imidazolate or a substituted imidazolate linking moiety, wherein M¹ and M² comprise the same or different metal cations, wherein at least one of M¹ and M² comprises a trivalent metal cation and wherein neither M¹ nor M² comprises a monovalent cation.

In a further aspect, the invention resides in an imidazolate framework material comprising a general structure, M¹-IM-M², wherein IM is a dicyanoimidazolate or a hydrolyzed or substituted dicyanoimidazolate linking moiety, wherein M¹ and M² comprise the same or different metal cations, wherein at least one of M¹ and M² comprises a trivalent metal cation and wherein neither M¹ nor M² comprises a monovalent cation.

In certain embodiments, at least one of M¹ and M² comprises a trivalent lanthanide cation.

In certain embodiments, M¹ and M² are both trivalent metal cations, for example the same trivalent metal cation, especially the same lanthanide cation.

In yet a further aspect, the invention resides in an imidazolate framework material comprising a general structure, M¹-IM-M², wherein IM is an imidazolate or a substituted imidazolate linking moiety, wherein M¹ and M² comprise the same or different metal cations, wherein at least one of M¹ and M² comprises a trivalent metal cation selected from the group consisting of aluminum, gallium, indium, iron, niobium, scandium, yttrium, and combinations thereof and wherein neither M¹ nor M² comprises a monovalent cation.

In still yet a further aspect, the invention resides in an imidazolate framework material comprising a general structure, M¹-IM-M², wherein IM is a dicyanoimidazolate or a hydrolyzed or substituted dicyanoimidazolate linking moiety, wherein M¹ and M² comprise the same or different metal cations, wherein at least one of M¹ and M² comprises a trivalent metal cation selected from the group consisting of aluminum, gallium, indium, iron, niobium, scandium, yttrium, and combinations thereof and wherein neither M¹ nor M² comprises a monovalent cation.

In certain embodiments, each of M¹ and M² is a trivalent metal cation, for example the same trivalent metal cation selected from the group consisting of aluminum, gallium, indium, iron, niobium, scandium, yttrium, and combinations thereof.

### BRIEF DESCRIPTION OF THE DRAWINGS

FIGS. 1(a-g) show X-ray diffraction patterns for the product of Example 1 and certain precursor and comparison materials.

FIG. 2 shows a scanning electron micrograph (SEM) image of the product of Example 1.

FIGS. 3(a-k) show X-ray diffraction patterns for the product of Example 2 at various temperatures from 30° C. to 500° C.

FIG. 4 shows the result of TGA analysis of the product of Example 2.

FIGS. 5(a-c) show X-ray diffraction patterns for the product of Example 3 and certain precursor materials.

FIG. 6 shows an SEM image of the product of Example 3.

FIGS. 7 and 8 show ¹³C NMR spectra of the product of Example 3.

FIGS. 9(a-g) show X-ray diffraction patterns for the products of Example 2 to 8.

FIG. 10 shows ²⁷Al NMR spectrum of the product of Example 6.

### DETAILED DESCRIPTION OF THE EMBODIMENTS

Disclosed herein are novel imidazolate framework materials having one or more trivalent metal cations, especially lanthanide cations and, in certain embodiments, dicyanoimadazole linking moieties. In particular, it has been found that using dicyanoimadazole as a linking agent can facilitate the direct synthesis of lanthanide and other trivalent metal imidazolate framework materials which, to date, has proven elusive with other linking agents.

In particular, the present imidazolate framework materials can advantageously have a framework comprising a general structure, M¹-IM-M², wherein IM is an imidazolate or a substituted imidazolate linking moiety, wherein M¹ and M² comprise the same or different metal cations, wherein at least one of M¹ and M² comprises a trivalent metal cation and wherein neither M¹ nor M² comprises a monovalent cation. Desirably, each of M¹ and M² can comprise a trivalent metal cation and, in certain embodiments, the same trivalent metal cation.

In one embodiment, at least one of, and desirably each of, M¹ and M² can comprise a trivalent lanthanide cation and, in certain embodiments, the same trivalent lanthanide cation.

As used herein, the term “lanthanide” is used to denote any of the fifteen metallic chemical elements with atomic numbers 57 through 71, from lanthanum through lutetium. In particular, the lanthanides include lanthanum, cerium, praseodymium, promethium, samarium, europium, gadolinium, terbium, dysprosium, holmium, erbium, thulium, ytterbium and lutetium.

Lanthanide imidazolate framework materials are of potential importance since lanthanides can have powerful Lewis acids and the nitrogen-lanthanide connectivity in such materials could be a potential source of Frustrated Lewis Pairs (FLPs), which in turn could activate a variety of small molecules (e.g., J. Am. Chem. Soc., 2009, 131 (10), 3476-3477, Chem. Rev., 2010, 110, 4023-4078). Thus, lanthanide imidazolate framework materials have potential utility in certain catalytic applications, such as hydrogenation, hydroformylation, and CH-activation, and additionally or alternatively as sorption media. Further additionally or alternatively, lanthanide imidazolate framework materials can be attractive as volatile metal containing precursors for vapor deposition processes, including chemical vapor deposition (CVD), atomic layer deposition (ALD), plasma-enhanced ALD (PEALD), pulsed CVD, and/or plasma enhanced CVD (PECVD) for fabricating conformal lanthanide metal containing films on substrates, such as: silicon, metal, metal nitride, metal silicon nitride, metal oxide, and other metal-containing layers.

In other embodiments, at least one of, and desirably each of, M¹ and M² can comprise a trivalent metal cation selected from the group consisting of aluminum, gallium, indium, iron, niobium, scandium, and yttrium cations, and combinations thereof. In certain embodiments, M¹ and M² can consist of the same trivalent metal cation selected from the group consisting of aluminum, gallium, indium, iron, niobium, scandium, and yttrium cations, and combinations thereof. Again, imidazolate framework materials containing these trivalent metal cations can have potential utility in catalytic and/or sorptive applications, as well as potentially in volatile metal containing precursors for the vapor deposition of trivalent metal containing films on substrates.

In certain embodiments, linking moiety IM employed in the present imidazolate framework materials can comprise a dicyanoimidazolate or a hydrolyzed or substituted dicyanoimidazolate and can desirably be derived from 4,5-dicyanoimidazole or a substituted 4,5 dicyanoimidazole having formula (IV) below

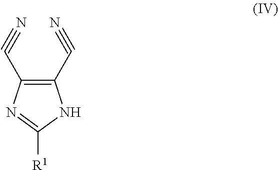

and/or its partially hydrolyzed form having formula V below and/or its fully hydrolyzed form having formula VI:

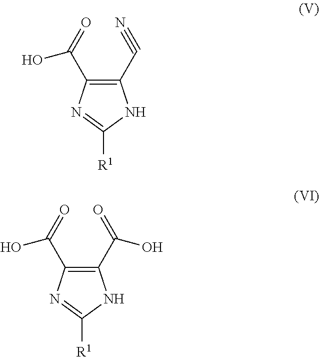

wherein R¹ can be any non-sterically hindering group that does not detrimentally interfere with M¹ or M² in the ZIF composition. In one embodiment, R¹ can be hydrogen.

The imidazolate framework materials disclosed herein may have tetrahedral framework structures characteristic of zeolitic materials. The framework types of the zeolitic imidazolate framework (ZIF) materials are denoted herein by a code consisting of three upper-case letters, in a similar manner to that used in the zeolite literature. It should be pointed out that a system of three-lower-case-letter symbols was introduced by O'Keeffe and Yaghi for the designation of the framework types of metal-organic frameworks (MOFs), meta-organic polyhedra (MOPs), zeolitic imidazolate frameworks (ZIFs), and covalent-organic frameworks (COFs). General information about the latter can be found, for example, in the publication by O'Keefe and Yaghi et al.,“Reticular Chemistry: Occurrence and Taxonomy of Nets and Grammar for the Design of Frameworks”, Accounts of Chemical Research, Vol. 38, 2005, pp. 176-82, and at http://resr.anu.edu.auhome, the Reticular Chemistry Structure Resource (RCSR) website. For the purpose of uniformity, all framework type codes used herein are typically expressed in upper-case letters.

Zeolitic forms of the imidazolate framework materials disclosed herein can include such structures iso-structural to known zeolites and related minerals, as well as structures unique to the field of ZIFs, for example, those identified in U.S. Patent Application Publication Nos. 2007/0202038 and 2010/0307336, including ABW, ACO, AEI AEL, AEN, AET, AFG, AFI, AFN, AFO, AFR, AFS, AFT, AFX, AFY, AHT, ANA, APC, APD, AST, ASV, ATN, ATO, ATS, ATT, ATV, AWO, AWW, BCT, BEA, BEC, BIK, BOG, BPH, BRE, CAG, CAN, CAS, CDO, CFI, CGF, CGS, CHA, CHI, CLO, CON, CRB, CZP, DAC, DDR, DFO, DFT, DIA, DOH, DON, EAB, EDI, EMT, EON, EPI, ERI, ESV, ETR, EUO, EZT, FAR, FAU, FER, FRA, FRL, GIS, GIU, GME, GON, GOO, HEU, IFR, IHW, ISV, ITE, ITH, ITW, IWR, IWV, IWW, JBW, KFI, LAU, LCS, LEV, LIO, LIT, LOS, LOV, LTA, LTL, LTN, MAR, MAZ, MEI, MEL, MEP, MER, MFI, MFS, MON, MOR, MOZ, MSE, MSO, MTE, MTN, MTT, MTW, MWW, NAB, NAT, NES, NON, NPO, NSI, OBW, OFF, OSI, OSO, OWE, PAR, PAU, PHI, PON, POZ, RHO, RON, RRO, RSN, RTE, RTH, RUT, RWR, RWY, SAO, SAS, SAT, SAV, SBE, SBS, SBT, SFE, SFF, SFG, SFH, SFN, SFO, SGT, SIV, SOD, SOS, SSY, STF, STI, STT, SZR, TER, THO, TON, TSC, TUN, UEI, UFI, UOZ, USI, UTL, VET, VFI, VNI, VSV, WEI, WEN, YUG, ZNI, and ZON. Such structures can include a tetrahedral framework type selected from the group consisting of CRB, DFT, CAG, SOD, MER, RHO, ANA, LTA, DIA, ZNI, GME, LCS, FRL, GIS, POZ, MOZ, and combinations thereof.

In some embodiments, the trivalent metal(s) in the imidazolate framework materials disclosed herein may be at least partially octahedrally coordinated. For example, the ratio of the degree of octrahedral coordination to tetrahedral coordination, if any, may exceed about 5:1, even exceeding about 10:1 in some cases. In addition, the imidazolate framework materials disclosed herein can potentially exhibit no significant mesoporosity but can still tend to have relatively high BET surface area values, such as in excess of about 100 m²/g, which is unusual for high atomic weight materials, such as lanthanides.

The present imidazolate framework materials can be synthesized, e.g., by contacting a solution of the dicyanoimidazole linking agent and a solution of a salt of the or each metal M¹ or M²in the same or different polar aprotic organic solvents at a temperature from about 25° C. to about 240° C. until crystals of the desired imidazolate framework material are formed. When the crystallization step is completed, normally in about 30 minutes to about 168 hours, the resultant crystalline product can be recovered.

The organic solvent used in the synthesis can advantageously be polar and aprotic, and it typically comprises or is an amide (e.g., N,N-dimethylformamide, N,N-dimethylacetamide, 1,3-dimethylpropyleneurea, or the like, or a combination thereof), a sulfoxide (e.g., dimethylsulfoxide), a phosphoramide (e.g., hexamethylphosphoramide), an ether (e.g., dimethyl ether, diethyl ether, methylethyl ether, or the like, or combinations thereof), or a combination thereof.

In some cases, the synthesis may be assisted by the addition to the reaction mixture of an organic base, such as piperazine and/or 1,4-dimethylpiperazine. While not wishing the be bound be any theory of operation, it is believed that the organic base may activate the relatively weaker base, imidazolate, to react with electrophilic metal cations, such as lanthanide (+3) cations.

If desired, the synthesis can be conducted in the presence of template, which can typically comprise or be a neutral organic compound, such as an ether, ketone, ester, amine, nitrile, nitro compound, phosphine, hydrocarbon, halide, or the like, or combination thereof.

In its as-synthesized form, the crystalline product may contain guest species, typically solvent and/or template molecules, within its framework structure. In most cases, the guest species can be removed, e.g., by evacuation at a pressure less than ˜50 mTorr at a temperature of about 70° C. to about 300° C., and/or by exchange with an organic solvent of small molecular size (e.g., acetonitrile), followed by evacuation such as described above. In the case of ZIF materials, the removal of guest species may result in internal pore volume that can be used to adsorb various gases, such as carbon dioxide, carbon monoxide, hydrocarbons, hydrogen, nitrogen, oxygen, noble gases, amines, and the like, as well as combinations thereof. The size and shape of the pores in the final ZIF material can be controlled by the choice of imidazolate linking moiety, solvent, and template, inter alia. As a result, these materials show significant potential as catalysts and in the storage/separation of gases.

Additionally or alternatively, the invention can be described by one or more of the following embodiments.

Embodiment 1. An imidazolate framework material comprising a general structure, M¹-IM-M², wherein IM is an imidazolate or a substituted imidazolate moiety, wherein M¹ and M² comprise the same or different metal cations, wherein at least one of M¹ and M² comprises a trivant metal cation and wherein neither M¹ nor M² comprises a monovalent cation.

Embodiment 2. The material of embodiment 1, wherein M¹ and M² are both trivalent metal cations, and/or wherein M¹ and M² are the same trivalent metal cation.

Embodiment 3. The material of embodiment 1 or embodiment 2, wherein at least one of M¹ and M² comprises a lanthanide cation.

Embodiment 4. The material of any one of the previous embodiments, wherein IM is a dicyanoimidazolate or a hydrolyzed or substituted dicyanoimidazolate linking moiety.

Embodiment 5. The material of any one of the previous embodiments, wherein at least one of M¹ and M² comprises a trivalent metal cation selected from the group consisting of aluminum, gallium, indium, iron, niobium, scandium, yttrium, and combinations thereof.

The invention will now be more particularly described with reference to the following non-limiting Examples and the accompanying drawings.

### EXAMPLES

### Example 1

### Synthesis of Gadolinium Imidazolate Framework Material

Gd(NO₃)₃.6H₂O (˜452 mg, 1 mmol) was loaded in a ˜50 mL beaker and dissolved in ˜10 mL of N,N-dimethyl formamide (DMF). 4,5-dicyanoimidazole (˜545 mg, ˜5 mmol) and piperazine (˜5 mmol, ˜430 mg) were dissolved in ˜10 mL DMF in another ˜25 mL beaker. The two solutions were mixed and heated in an autoclave reactor at ˜140° C. for 24 hours. A solid grey colored precipitate was formed that was washed with additional ˜20 mL of DMF followed by ˜30 mL of acetonitrile. The material was subjected to solvent exchange in a scintillation vial 3 times with another 3×˜10 mL acetonitrile. The solid residue was dried under vacuum overnight (about 8-16 hours) and analyzed by SEM and powder x-ray diffraction.

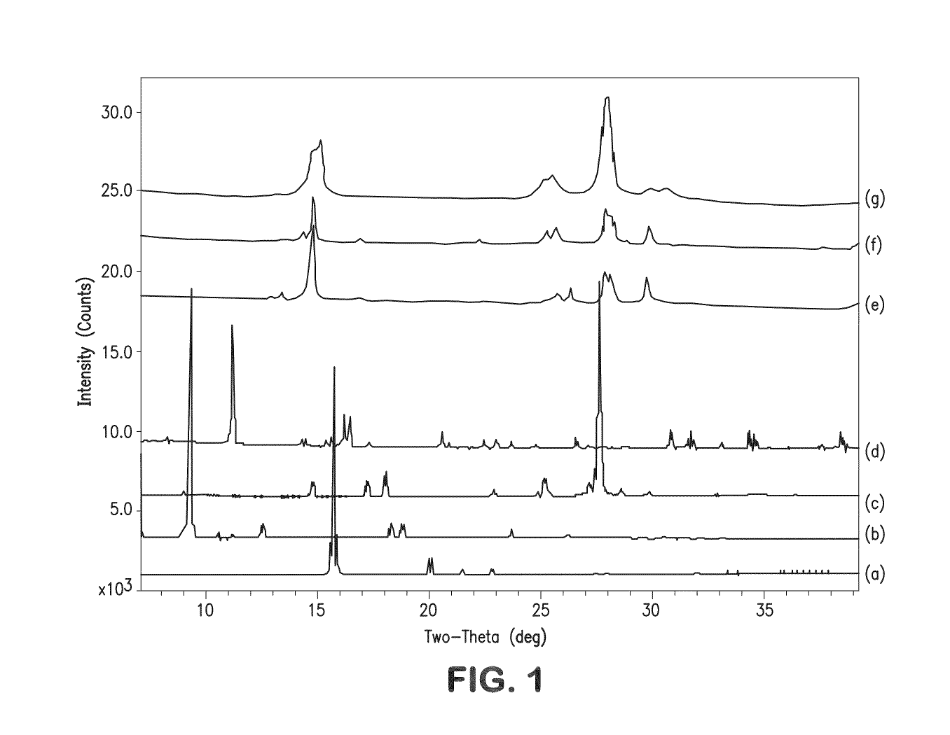

The powder XRD data of the precursors and product are shown in FIG. 1 and demonstrate the formation of a new material appearing markedly different than all of the starting materials. In FIG. 1, pattern (a) shows the XRD data for piperazine (crushed), pattern (c) shows the XRD data for 4,5-dicyanoimidazole (crushed), pattern (d) shows the XRD data for gadolinium (III) nitrate hexahydrate (crushed), pattern (e) shows the XRD data for the dried gadolinium imidazolate framework product (crushed), pattern (f) shows the XRD data for a dried and crushed gadolinium imidazolate framework product produced in a repeat experiment.

Also shown in FIG. 1 are the XRD data for crushed zinc phthalocyanine (pattern b) and for the dried and crushed gadolinium imidazolate framework product after treatment with a solution of zinc phthalocyanine DMF (pattern g). The similarity of the patterns (e), (f), and (g) suggests the treatment resulted in no incorporation of the pthalocyanine ligand in the imidazolate framework.

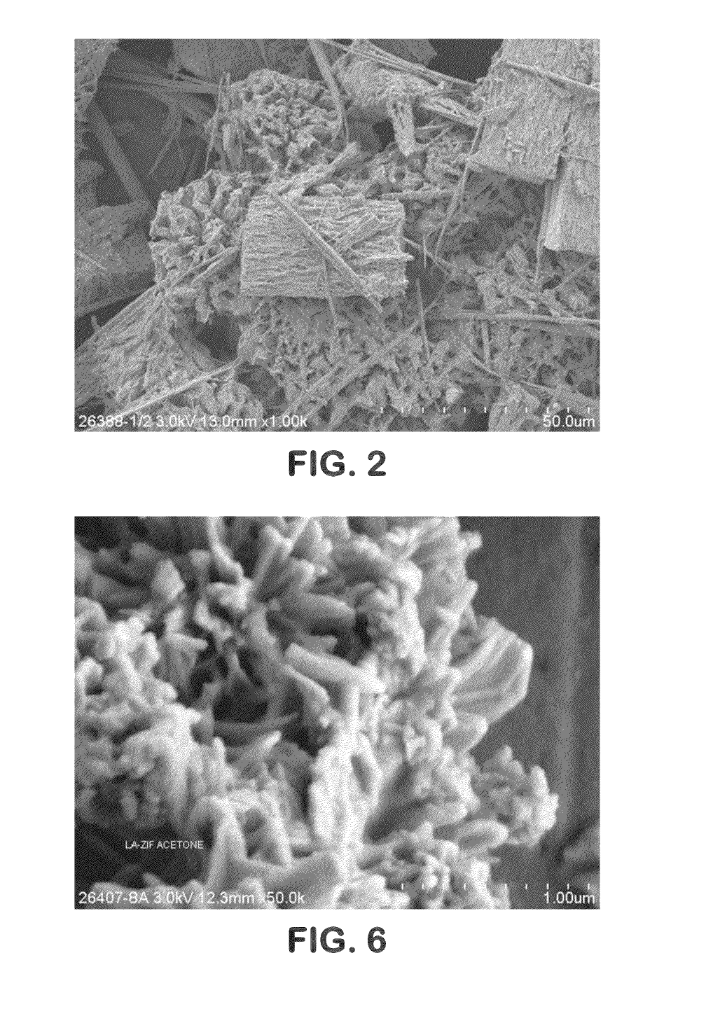

The SEM analysis (FIG. 2) showed that the product had a high degree of porosity and was composed of two kinds of materials. This was confirmed by solid state ¹³C MAS NMR where the presence of both piperazine and 4,5-dicyanoimidazole was detected. Vibrational spectroscopic data (IR and Raman) confirmed the presence of nitrile groups along with piperazine. Elemental Analysis confirmed the presence of gadolinium.

BET measurement showed that the product had a surface area of ˜120 m²/g.

### Example 2

### Synthesis of Gadolinium Imidazolate Framework Material

The synthesis of Example 1 was repeated but with the 4,5-dicyanoimidazole being dissolved in 1,4-dimethylpiperazine and the molar ratio of 4,5-dicyanoimidazole:1,4 dimethylpiperazine:Gd(NO₃)₃.6H₂O being ˜3:˜3:˜1.

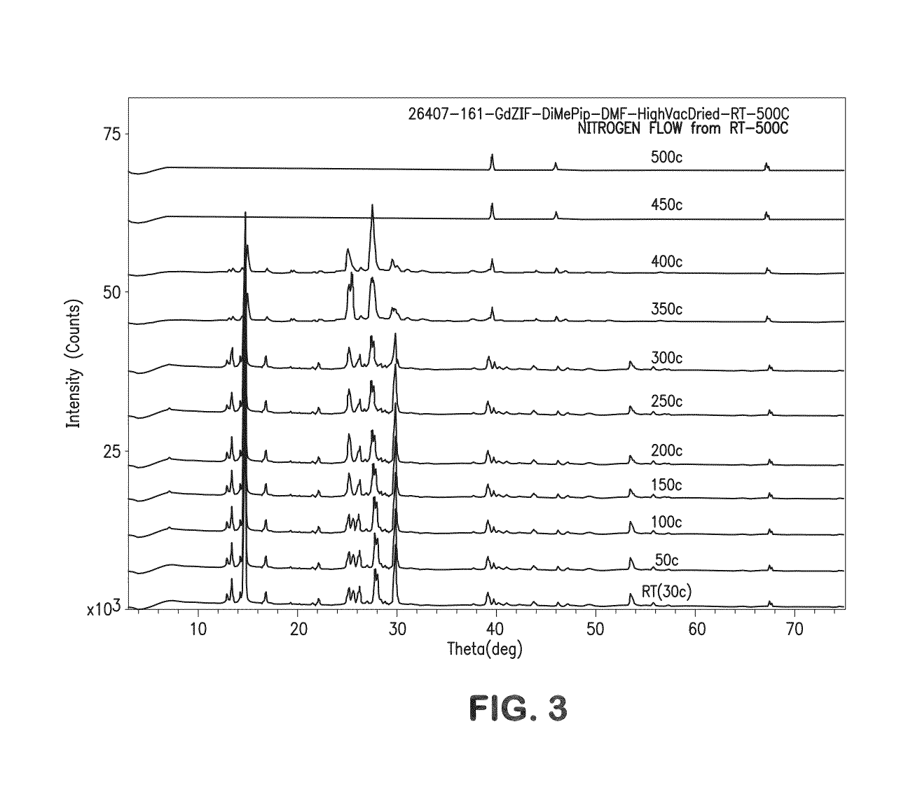

After solvent exchange with 3×˜10 mL of acetonitrile, the solid residue was dried under vacuum overnight (for about 8-16 hours) at 30° C. and analyzed by XRD. The results are shown in FIG. 3(a). The product was then heated in flowing nitrogen to ˜500° C. and XRD data were taken at ˜50° C. and subsequently at every ˜50° C. interval as the temperature was increased to ˜500° C. The results are shown in FIG. 3(b) to FIG. 3(k) and show the product to exhibit high stability at least until about 400° C.

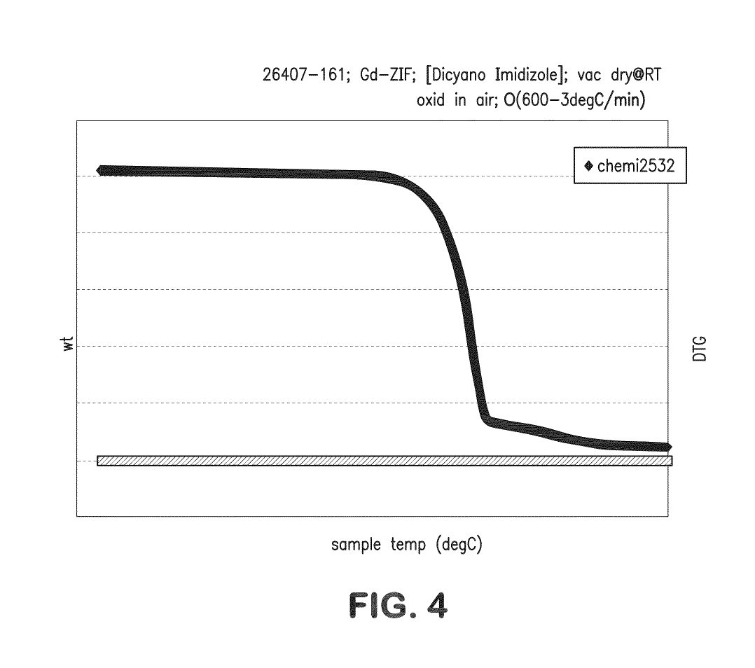

A further sample of the vacuum dried residue was subjected to thermogravimetric analysis (TGA) by heating in air for ˜600° C. at ˜3° C./minute heating rate. The results are shown in FIG. 4 and not only confirm the high thermal stability of the material but also show that part of the product seems to have sublimed and collected in the exhaust line during the TGA experiment, thereby preventing a reliable determination of the ligand:Gd³⁺ molar ratio.

### Example 3

### Synthesis of Lanthanum Imidazolate Framework Material

About 3.54 grams of 4,5-dicyanoimidazole (˜30 mmol), about 3.42 grams of 1,4-dimethylpiperazine (˜30 mmol), and about 4.33 grams (˜10 mmol) of lanthanum nitrate (La(NO₃)₃.6H₂O) were dissolved in N,N-dimethyl formamide (DMF) were assembled in a ˜25 cc Parr reactor and were kept at a temperature of ˜140° C. for ˜3 days. A solid white colored precipitate was formed that was filtered and washed with ˜25 mL of N,N-dimethyl-formamide, followed by ˜25 mL of acetonitrile. Vacuum drying of the precipitate for ˜3 hours at ˜100° C. yielded about 6 grams of a solid product which was then analyzed by XRD and SEM.

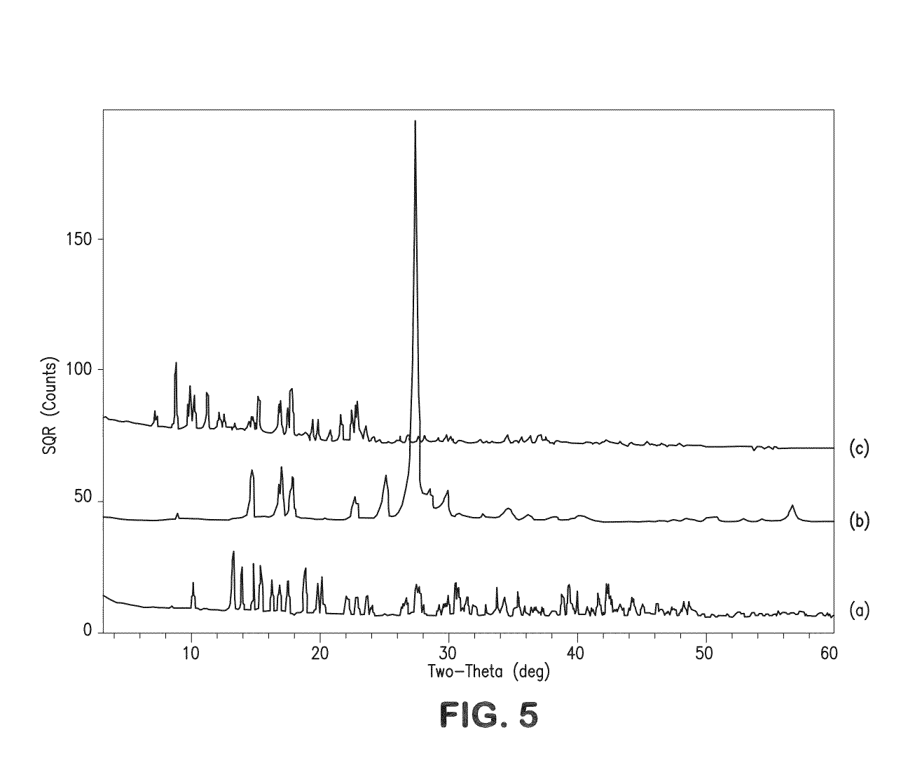

The powder XRD data of the product are shown in FIG. 5 and demonstrate the formation of a new material appearing markedly different than all of the starting materials. In FIG. 5, pattern (a) shows the XRD data for lanthanum (III) nitrate hexahydrate (crushed), pattern (b) shows the XRD data for 4,5-dicyanoimidazole (crushed), and pattern (c) shows the XRD data for the dried lanthanum imidazolate framework product (crushed).

The SEM image of the product is shown in FIG. 6 and suggests that the product is a single phase material with a high degree of porosity. This result suggests that, by substituting piperazine with 1,4-dimethyl piperazine as base, it was possible to reduce the level of coproduct coming from a second phase as seen in Example 1.

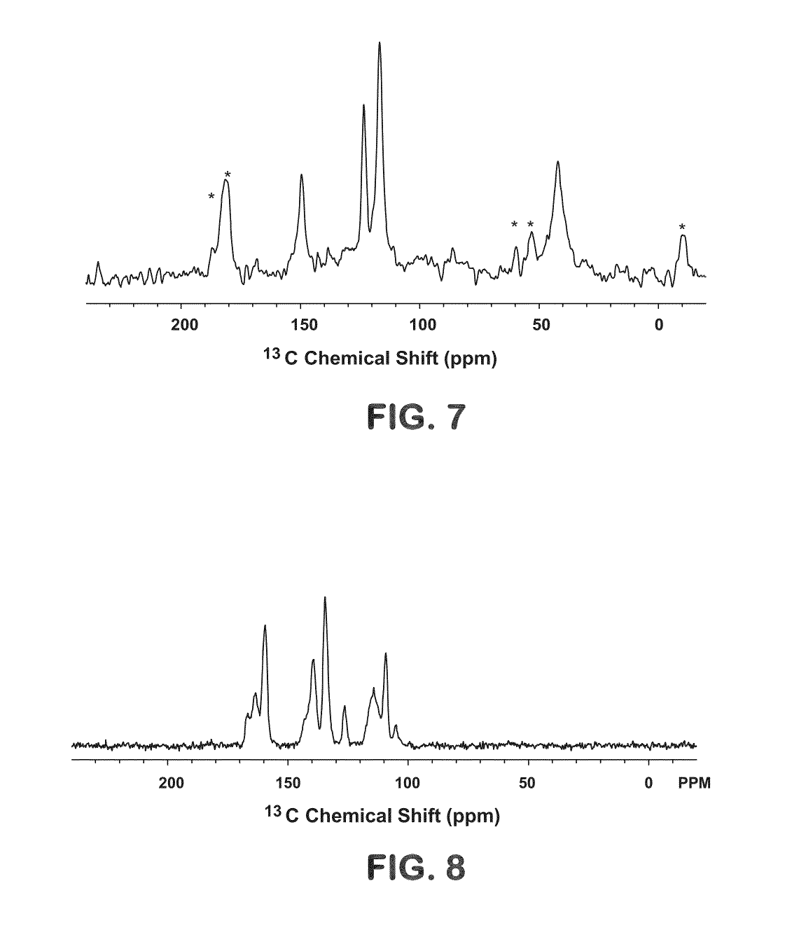

FIG. 7 provides a 125.53 MHz ¹³C Bloch decay magic-angle spinning NMR spectrum of the vacuum dried product acquired with a pulse delay of ˜180 seconds using a ˜5 mm rotor spinning at ˜8 kHz, in which asterisks indicate spinning sidebands. The peak centered at around 42 ppm indicates the presence of piperazine or piperazine-containing moiety. The rest of the peaks (around 117, 123, and 149 ppm) correspond to the dicyanoimidazolate moiety (diCNIm), with peaks around ˜102, 53, 59, 181, and 187 ppm being identified as spinning sidebands in the spectrum by asterisks. The spinning sidebands were confirmed by performing different spinning speed experiments. The SEM images that indicated different morphologies appear to be consistent with the NMR observation of the incorporation of the piperazine and the dicyanoimidazolate moieties.

FIG. 8 provides a 125.53 MHz ¹³C cross-polarization magic-angle spinning NMR spectrum of the vacuum dried product after heat treatment at ˜140° C. for ˜12 hours. The spectrum was acquired with a ¹H-¹³C cross polarization contact time of ˜2.5 ms using a ˜1.6-mm rotor spinning at ˜40 kHz and a pulse delay of ˜60 seconds. The spectrum appeared to exhibit the dicyanoimidazolate structure and its hydrolyzed or substituted form. The absence of the piperazine (believed to be solid at room/ambient temperature) moiety was presumed to be due to the fact that, in this synthesis, the 1,4-dimethyl piperazine (believed to be liquid at room/ambient temperature) was used as a base.

### Examples 4-7

### Synthesis of Further Trivalent Metal Imidazolate Frameworks

Using the ˜3:˜3:˜1 molar ratio of 4,5-dicyanoimidazole:1,4 dimethylpiperazine:trivalent metal precursor in N,N-dimethylformamide as solvent, the process of Example 3 was repeated with the following trivalent metal precursors: Praseodymium nitrate (Pr(NO₃)₃.6H₂O)—Example 4; Ytterbium nitrate (Yb(NO₃)₃.6H₂O)—Example 5; Aluminum nitrate (Al(NO₃)₃.9H₂O)—Example 6; and Iron (III) nitrate (Fe(NO₃)₃.9H₂O)—Example 7.

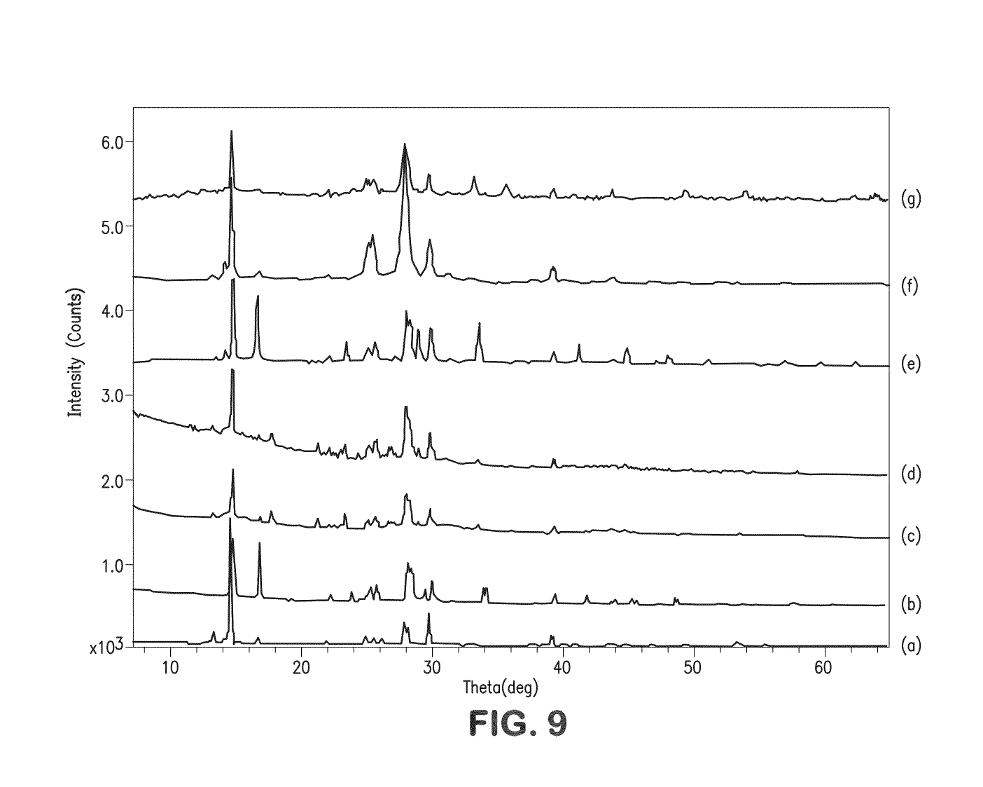

The XRD data on the resultant products are shown in FIG. 9, in which pattern (b) provides the XRD pattern for the product of Example 4, pattern (c) provides the XRD pattern for the product of Example 5, pattern (f) provides the XRD pattern for the product of Example 6, and pattern (g) provides the XRD pattern for the product of Example 7. For comparison, patterns (a) and (e) provide the XRD patterns for the products of Examples 2 and 3, respectively. In addition, pattern (d) in FIG. 9 shows the XRD data for the product of Example 8, a repeat of Example 2 but with the solvent for the Gd(NO₃)₃.6H₂O being diethylether instead of N,N-dimethylformamide. It may be seen that the change of solvent appeared to result in the imidazolate framework product of Example 8 having a different structure from the material of Example 2.

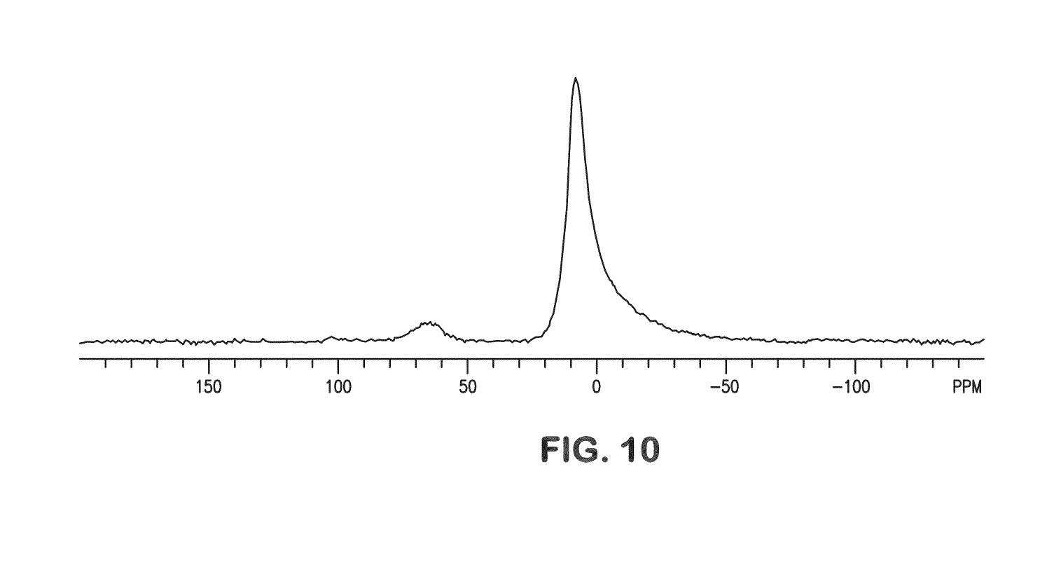

FIG. 10 provides a ˜130.1 MHz ²⁷Al Bloch decay magic-angle spinning NMR spectrum of the aluminum imidazolate framework product of Example 6 acquired with a pulse delay of ˜0.3 seconds using ˜4 mm rotor spinning at ˜12 kHz. The ²⁷Al MAS NMR shows that ˜93 mol % of the total aluminum appeared to be octahedrally coordinated and ˜7 mol % appeared to be tetrahedrally coordinated (peak centered around 65 ppm). Asterisks in the figure were used to designate spinning sidebands.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

What is claimed is:

1. An imidazolate framework material comprising a general structure, M¹-IM-M², wherein IM is an imidazolate or a substituted imidazolate linking moiety, wherein M¹ and M² comprise the same or different metal cations, wherein at least one of M¹ and M² comprises a trivalent metal cation and wherein neither M¹ nor M² comprises a monovalent cation.

2. The material of claim 1, wherein M¹ and M² are both trivalent metal cations.

3. The material of claim 2, wherein M¹ and M² are the same trivalent metal cation.

4. The material of claim 1, wherein at least one of M¹ and M² comprises a lanthanide cation.

5. An imidazolate framework material comprising a general structure, M¹-IM-M², wherein IM is a dicyanoimidazolate or a hydrolyzed or substituted dicyanoimidazolate linking moiety, wherein M¹ and M² comprise the same or different metal cations, wherein at least one of M¹ and M² comprises a trivalent metal cation and wherein neither M¹ nor M² comprises a monovalent cation.

6. The material of claim 5, wherein M¹ and M² are both trivalent metal cations.

7. The material of claim 6, wherein M¹ and M² are the same trivalent metal cation.

8. The material of claim 5, wherein at least one of M¹ and M² comprises a lanthanide cation.

9. An imidazolate framework material comprising a general structure, M¹-IM-M², wherein IM is an imidazolate or a substituted imidazolate linking moiety, wherein M¹ and M² comprise the same or different metal cations, wherein at least one of M¹ and M² comprises a trivalent metal cation selected from the group consisting of aluminum, gallium, indium, iron, niobium, scandium, yttrium, and combinations thereof and wherein neither M¹ nor M² comprises a monovalent cation.

10. The material of claim 9, wherein M¹ and M² are both trivalent metal cations.

11. The material of claim 10, wherein M¹ and M² are the same trivalent metal cation.

12. An imidazolate framework material comprising a general structure, M¹-IM-M², wherein IM is a dicyanoimidazolate or a hydrolyzed or substituted dicyanoimidazolate linking moiety, wherein M¹ and M² comprise the same or different metal cations, wherein at least one of M¹ and M² comprises a trivalent metal cation selected from the group consisting of aluminum, gallium, indium, iron, niobium, scandium, yttrium, and combinations thereof and wherein neither M¹ nor M² comprises a monovalent cation.

13. The material of claim 12, wherein M¹ and M² are both trivalent metal cations.

14. The material of claim 13, wherein M¹ and M² are the same trivalent metal cation.
